(19) United States
(12) Patent Application Publication
(10) Pub. No.: US 2022/0217225 A1
(43) Pub. Date: Jul. 7, 2022

(54) Handling of SCTP Packets with T-bit Set at SCTP Load Balancer

(71) Applicant: Parallel Wireless, Inc., Nashua, NH (US)

(72) Inventors: Anoop Gupta, Pune (IN); Kartik Shashikant Raval, Pune (IN); Sanjay Harwani, Pune (IN)

(21) Appl. No.: 17/569,626

(22) Filed: Jan. 6, 2022

Related U.S. Application Data
(60) Provisional application No. 63/134,329, filed on Jan. 6, 2021.

(51) Int. Cl. H04L 69/163; H04L 43/10; H04L 43/028; H04L 47/32; H04L 12/46

(52) U.S. Cl. CPC H04L 69/163; H04L 43/10; H04L 12/4633; H04L 47/32; H04L 43/028

(57) ABSTRACT

Systems, methods and computer software are disclosed for handling Stream Control Transmission Protocol (SCTP) packets with T-bit set at an SCTP load balancer. In one embodiment a method is disclosed, the method including embedding bits in an SCTP verification tag during SCTP association to identify a correct backend-server instance; parsing the verification tag to obtain an embedded instance number of the backend server; and routing, based on the embedded instance number, the SCTP packets to a correct backend server for further processing.

### CROSS-REFERENCE TO RELATED APPLICATIONS

This application claims priority under 35 U.S.C. § 119(e) to U.S. Provisional Pat. App. No. 63/134,329, filed Jan. 6, 2020, titled “Handling of SCTP Packets with T-bit Set at SCTP Load Balancer” which is hereby incorporated by reference in its entirety for all purposes. This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

Stream Control Transmission Protocol (SCTP) Load Balancers (LBs) are primarily meant for distributing the traffic load across the multiple service-endpoints running on multiple backend physical or Virtual machines. In general, Load balancers help in increasing the capacity, performance, responsiveness or availability of the applications by distributing the load across multiple backend servers and helps in scaling the system horizontally.

SCTP LB needs to be very fast and thus, it is expected that LB shall perform minimal processing on inbound traffic for routing to the backend-servers. Also, SCTP LB needs to be persistent and have a deterministic behavior for SCTP i.e. the SCTP packets should get mapped to same service end-point based on 5 tuple values or any other unique key mechanism to identify the SCTP association. Also, we want the SCTP LB to be a stateless entity to avoid the maintenance of peer-information across service restart, etc.

One SCTP association between two peers is identified by the combination of SCTP end-points and SCTP-verification tags of each peer. A verification tag is a 4 bytes unsigned integer that uniquely identifies the current association. Each SCTP-end-point generates a unique SCTP verification tag and exchange it during the SCTP association in the SCTP Init and Init-ACK packets. Going forward, all the subsequent SCTP packets need to provide the verification tag of the peer so that the peer could validate that the SCTP packet belongs to the correct SCTP-association.

A SCTP load balancer could maintain a map of SCTP-association and its verification tag. When the SCTP packets are received at the SCTP LB, the SCTP-LB shall identify the backend-server based on the verification tag to the backend-server map.

A better option would be to embed certain bits in the SCTP verification tag during the SCTP association which will identify the correct back-end-server instance. This way, there SCTP load balancer doesn't need to store and maintain the SCTP association and verification tag-based map to identify the backend-server. The SCTP LB just need to parse the verification tag and get the embedded instance-number of the back-end server and based on the embedded instance-number, the SCTP packets will get routed to the correct back-end server for further processing.

### SUMMARY

Systems, methods and computer readable media are described for handling of SCTP packets with a T-bit set at an SCTP load balancer. In one embodiment a method is described which will embed certain bits in the SCTP verification tag during the SCTP association which will identify the correct back-end-server instance. This way, there SCTP load balancer doesn't need to store and maintain the SCTP association and verification tag-based map to identify the backend-server. The SCTP LB just need to parse the verification tag and get the embedded instance-number of the back-end server and based on the embedded instance-number, the SCTP packets will get routed to the correct back-end server for further processing.

In another embodiment a wireless network system includes an SCTP load balancer; a plurality of backend servers, each backed server in communication with the SCTP load balancer; wherein bits are embedded in an SCTP verification tag during SCTP association to identify a correct backend server instance; the verification tag is parsed to obtain an embedded instance number of the backend server; and the SCTP packets are routed to a correct backend server for further processing based on the embedded instance number.

In another embodiment, a non-transitory computer-readable medium contains instructions for operating a wireless network system containing instructions for handling SCTP packets which, when executed, cause the system to perform steps comprising: embedding bits in an SCTP verification tag during SCTP association to identify a correct backend-server instance; parsing the verification tag to obtain an embedded instance number of the backend server; and routing, based on the embedded instance number, the SCTP packets to a correct backend server for further processing.

### BRIEF DESCRIPTION OF THE DRAWINGS

FIG. 1 is a diagram showing signaling for handling SCTP packets with the T-bit set, in accordance with some embodiments.

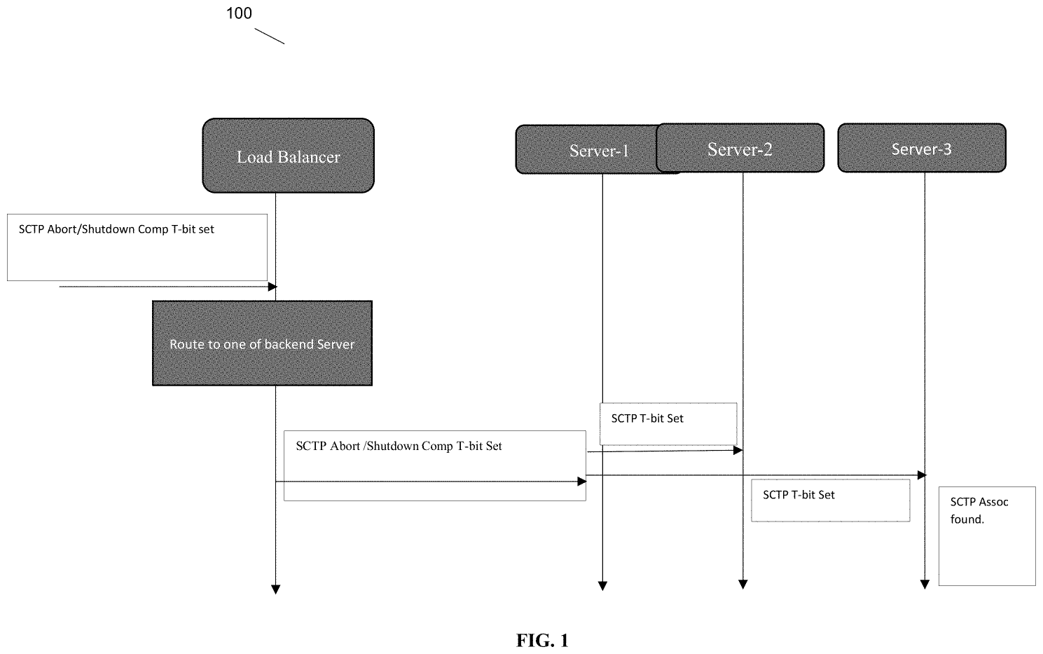

FIG. 2 is a block diagram of an SCTP load balancer, in accordance with some embodiments.

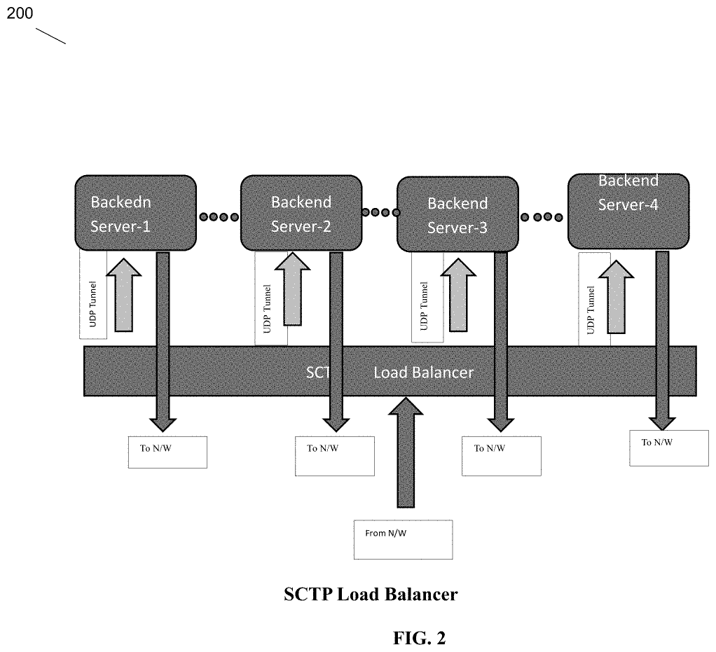

FIG. 3 is a flow diagram of a method of providing signaling for handling SCTP packets with the T-bit set, in accordance with some embodiments.

FIG. 4 is a network diagram in accordance with some embodiments.

FIG. 5 is an enhanced eNodeB for performing the methods described herein, in accordance with some embodiments.

FIG. 6 is a coordinating server for providing services and performing methods as described herein, in accordance with some embodiments.

### DETAILED DESCRIPTION

An SCTP Load balancer (LB) is a critical component in a distributed network. One important aspect of SCTP LB is the requirement of single IP for the hosted service in the backend servers. The multiple backend servers shall open RAW sockets for same IP for a service. This means that SCTP LB needs to select or distribute the inbound SCTP traffic to one of the pluralities of backend servers listening on same IP and port. SCTP-LB may apply consistent Hashing algorithm over the inbound SCTP INIT at SCTP-LB and use the local SCTP verification tag, during the creation of SCTP association, as a selector to determine a back-end server for subsequent SCTP packets. This will work seamlessly as long as the inbound SCTP packets have locally generated SCTP verification tag. However, there are some cases where the peer-SCTP may provide its own verification tag and sets the T-bit in SCTP packets such as SCTP Abort and Shutdown Complete and in such cases a special handling is required at the SCTP Load balancer.

A stateless SCTP LB may use the verification tag present in the SCTP packet to determine the backend server where it has to forward the SCTP packet.

When SCTP LB gets SCTP packets with T-bit set, the cases where peer has set its own verification tag, in such cases, the SCTP LB shall not be able to correctly forward the SCTP packet to correct backend Server which has the SCTP association for the corresponding peer and in such cases, the SCTP ABORT or SHUTDOWN Complete packet from peer shall go to Wrong Backend Server and thus, the System will not be aware of the peer-association getting down or it shall delay the detection of peer-down.

This proposal talks about handling this use-case where we get the SCTP Packet with T-bit set. There are two ways by which we may handle it:

The SCTP LB peeks into the packet and check if T-bit is set and it if is set, then multicast the SCTP packet to all of the SCTP backend-server listening on this IP and port. This requires extra processing on SCTP LB of peeking and checking the T-bit for each and every SCTP packet and hence, it will not be performance effective.

The alternate way is to let SCTP LB select any backend-server based on the verification-tag or use consistent hashing algorithm so that the SCTP packet gets routed to one of the backend Server listening on that SCTP IP and port.

Once, SCTP packet reaches a backend-server, if it is case of T-bit set in case of SCTP Abort and Shutdown Complete, then backend server will now multicast it to all the backend server along with processing the SCTP packet. This will ensure that the SCTP packet will reach the correct Backend-Server. The backend-server which doesn't have the SCTP association may silently discard such SCTP Abort and ShutDown Complete packet as per the RFC and the correct SCTP backend server will clear the SCTP association.

The peer sends Abort/Shutdown Complete with T-bit set which reaches the SCTP load balancer.

The SCTP load balancer looks up the task and tunnels the Abort towards one of the backend server tasks based on a Verification tag (Vtag).

If T-bit is set, then the SCTP Abort/shutdown Complete shall contain the verification tag of the SCTP peer and hence, selected backend Server shall multicast the SCTP Abort to all remaining Servers listening on same IP and port.

The Correct backend Server with peer SCTP association shall process it and remaining backend-Server shall ignore the packet.

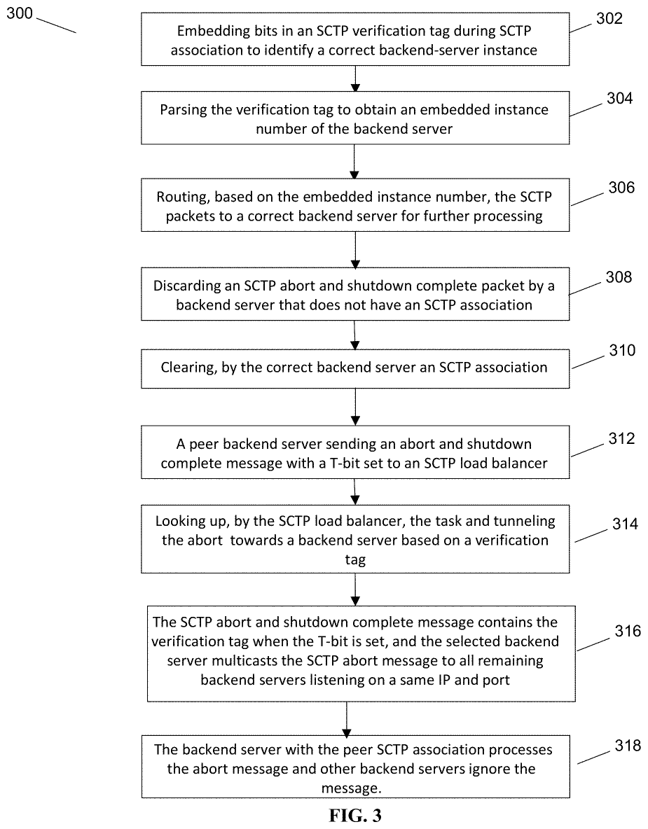

Flow charts of particular embodiments of the presently disclosed methods is depicted in FIG. 3. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language or hardware implementation. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 3, an example embodiment of a method 300 of handling Stream Control Transmission Protocol (SCTP) packets is shown. Method 300 begins with processing block 302 which shows embedding bits in an SCTP verification tag during SCTP association to identify a correct backend-server instance. Processing block 304 shows parsing the verification tag to obtain an embedded instance number of the backend server. Processing block 306 recites routing, based on the embedded instance number, the SCTP packets to a correct backend server for further processing.

Processing block 308 discloses discarding an SCTP abort and shutdown complete packet by a backend server that does not have an SCTP association. Processing block 310 shows clearing, by the correct backend server an SCTP association.

Processing block 312 discloses a peer backend server sending an abort and shutdown complete message with a T-bit set to an SCTP load balancer. Processing block 314 states looking up, by the SCTP load balancer, the task and tunneling the abort towards a backend server based on a verification tag. Processing block 316 recites wherein the SCTP abort and shutdown complete message contains the verification tag when the T-bit is set, and the selected backend server multicasts the SCTP abort message to all remaining backend servers listening on a same IP and port, and processing block 318 discloses the backend server with the SCTP association processes the abort message and other backend servers ignore the message.

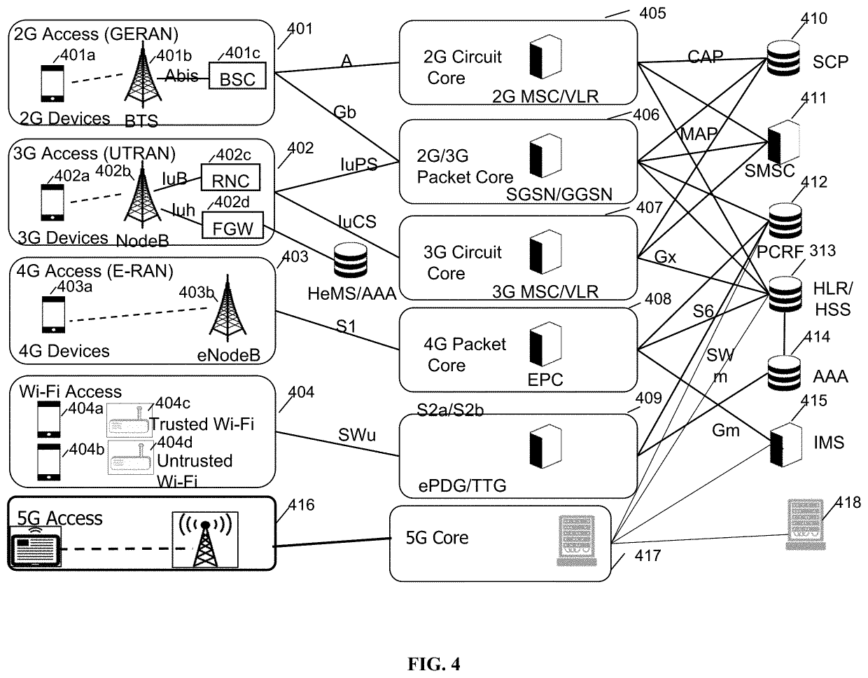

FIG. 4 *is a schematic network architecture diagram for 3G and other-G prior art networks. The diagram shows a plurality of “Gs,” including 2G, 3G, 4G, 5G and Wi-Fi. 2G is represented by GERAN 401, which includes a 2G device 401a, BTS 401b, and BSC 401c. 4G is represented by UTRAN 402, which includes a 4G UE 402a, nodeB 402b, RNC 402c, and femto gateway (FGW, which in 4GPP namespace is also known as a Home nodeB Gateway or HNBGW) 402d. 4G is represented by EUTRAN or E-RAN 403, which includes an LTE UE 403a and LTE eNodeB 403b. Wi-Fi is represented by Wi-Fi access network 404, which includes a trusted Wi-Fi access point 404c and an untrusted Wi-Fi access point 404d. The Wi-Fi devices 404a and 404b may access either AP 404c or 404d. In the current network architecture, each “G” has a core network. 2G circuit core network 405 includes a 2G MSC/VLR; 2G/3G packet core network 406 includes an SGSN/GGSN (for EDGE or UMTS packet traffic); 4G circuit core 407 includes a 4G MSC/VLR; 4G circuit core 408 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 430, the SMSC 431, PCRF 432, HLR/HSS 433, Authentication, Authorization, and Accounting server (AAA) 434, and IP Multimedia Subsystem (IMS) 435. An HeMS/AAA 436 is present in some cases for use by the 4G UTRAN. The diagram is used to indicate schematically the basic functions of each network as known to one of skill in the art, and is not intended to be exhaustive. For example, 5G core 417 is shown using a single interface to 5G access 416, although in some cases 5G access can be supported using dual connectivity or via a non-standalone deployment architecture.

Noteworthy is that the RANs 401, 402, 403, 404 and 436 rely on specialized core networks 405, 406, 407, 408, 409, 437 but share essential management databases 430, 431, 432, 433, 434, 435, 438. More specifically, for the 2G GERAN, a BSC 401c is required for Abis compatibility with BTS 401b, while for the 4G UTRAN, an RNC 402c is required for Iub compatibility and an FGW 402d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

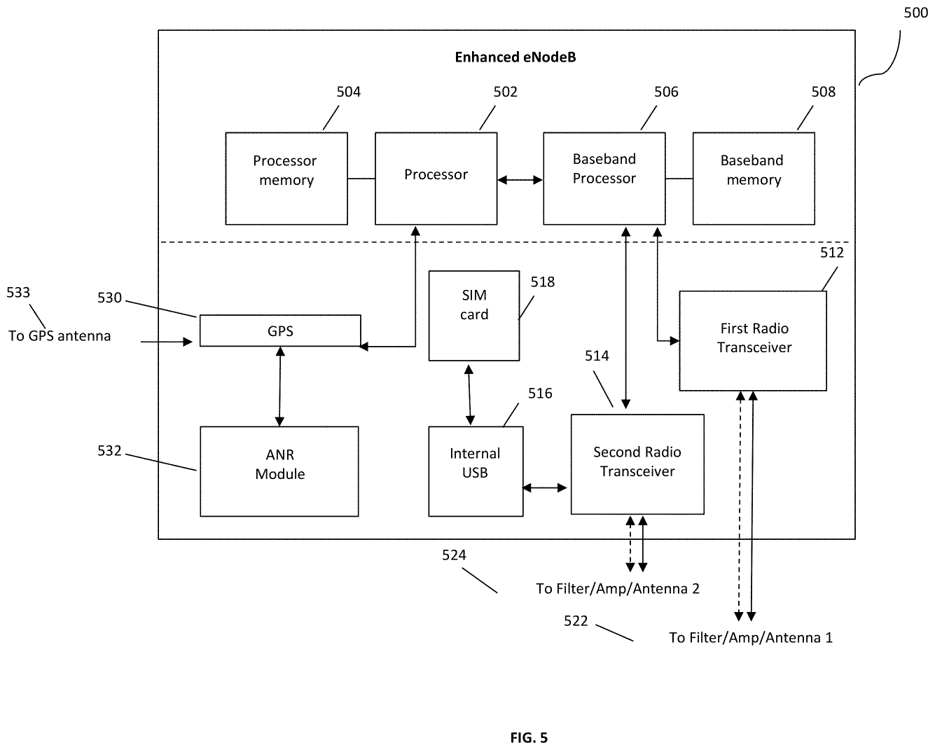

FIG. 5 is an enhanced eNodeB for performing the methods described herein, in accordance with some embodiments. Mesh network node 400 may include processor 502, processor memory 504 in communication with the processor, baseband processor 506, and baseband processor memory 508 in communication with the baseband processor. Mesh network node 500 may also include first radio transceiver 512 and second radio transceiver 514, internal universal serial bus (USB) port 516, and subscriber information module card (SIM card) 518 coupled to USB port 516. In some embodiments, the second radio transceiver 514 itself may be coupled to USB port 516, and communications from the baseband processor may be passed through USB port 516. The second radio transceiver may be used for wirelessly backhauling eNodeB 500.

Processor 502 and baseband processor 506 are in communication with one another. Processor 502 may perform routing functions, and may determine if/when a switch in network configuration is needed. Baseband processor 506 may generate and receive radio signals for both radio transceivers 512 and 514, based on instructions from processor 502. In some embodiments, processors 502 and 506 may be on the same physical logic board. In other embodiments, they may be on separate logic boards.

Processor 502 may identify the appropriate network configuration, and may perform routing of packets from one network interface to another accordingly. Processor 502 may use memory 504, in particular to store a routing table to be used for routing packets. Baseband processor 506 may perform operations to generate the radio frequency signals for transmission or retransmission by both transceivers 510 and 512. Baseband processor 506 may also perform operations to decode signals received by transceivers 512 and 514. Baseband processor 506 may use memory 508 to perform these tasks.

The first radio transceiver 512 may be a radio transceiver capable of providing LTE eNodeB functionality, and may be capable of higher power and multi-channel OFDMA. The second radio transceiver 514 may be a radio transceiver capable of providing LTE UE functionality. Both transceivers 512 and 514 may be capable of receiving and transmitting on one or more LTE bands. In some embodiments, either or both of transceivers 512 and 514 may be capable of providing both LTE eNodeB and LTE UE functionality. Transceiver 512 may be coupled to processor 502 via a Peripheral Component Interconnect-Express (PCI-E) bus, and/or via a daughtercard. As transceiver 514 is for providing LTE UE functionality, in effect emulating a user equipment, it may be connected via the same or different PCI-E bus, or by a USB bus, and may also be coupled to SIM card 518. First transceiver 512 may be coupled to first radio frequency (RF) chain (filter, amplifier, antenna) 522, and second transceiver 514 may be coupled to second RF chain (filter, amplifier, antenna) 524.

SIM card 518 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 500 is not an ordinary UE but instead is a special UE for providing backhaul to device 500.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 512 and 514, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 502 for reconfiguration.

A GPS module 530 may also be included, and may be in communication with a GPS antenna 532 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 532 may also be present and may run on processor 502 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

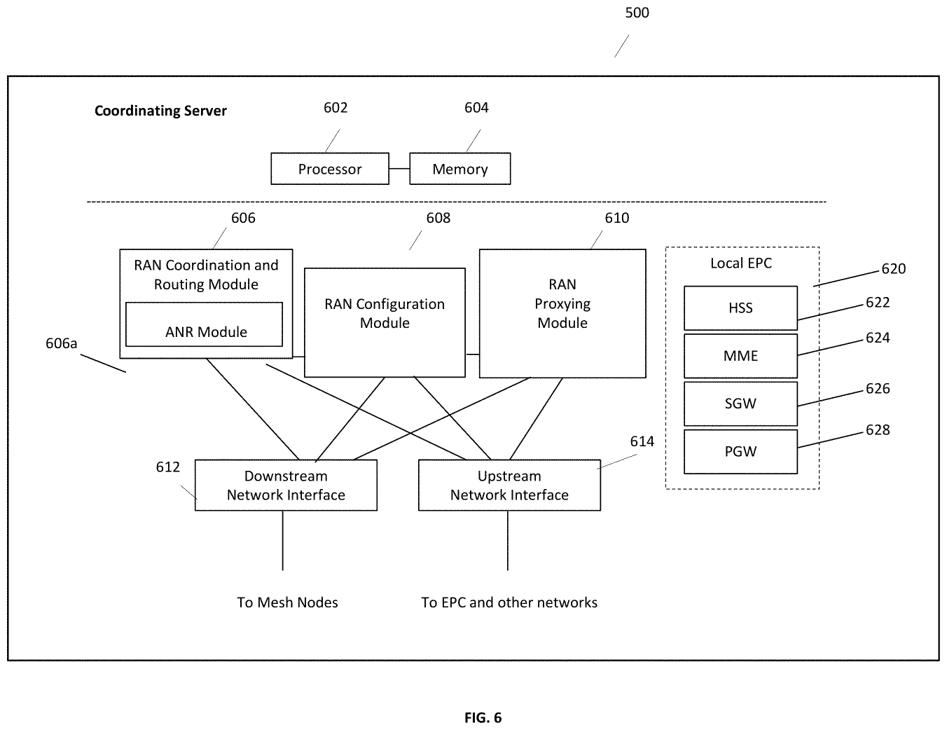

FIG. 6 is a coordinating server for providing services and performing methods as described herein, in accordance with some embodiments. Coordinating server 500 includes processor 602 and memory 604, which are configured to provide the functions described herein. Also present are radio access network coordination/routing (RAN Coordination and routing) module 606, including ANR module 606a, RAN configuration module 608, and RAN proxying module 610. The ANR module 606a may perform the ANR tracking, PCI disambiguation, ECGI requesting, and GPS coalescing and tracking as described herein, in coordination with RAN coordination module 606 (e.g., for requesting ECGIs, etc.). In some embodiments, coordinating server 600 may coordinate multiple RANs using coordination module 606. In some embodiments, coordination server may also provide proxying, routing virtualization and RAN virtualization, via modules 610 and 608. In some embodiments, a downstream network interface 612 is provided for interfacing with the RANs, which may be a radio interface (e.g., LTE), and an upstream network interface 614 is provided for interfacing with the core network, which may be either a radio interface (e.g., LTE) or a wired interface (e.g., Ethernet).

Coordinator 600 includes local evolved packet core (EPC) module 620, for authenticating users, storing and caching priority profile information, and performing other EPC-dependent functions when no backhaul link is available. Local EPC 620 may include local HSS 622, local MME 624, local SGW 626, and local PGW 628, as well as other modules. Local EPC 620 may incorporate these modules as software modules, processes, or containers. Local EPC 620 may alternatively incorporate these modules as a small number of monolithic software processes. Modules 606, 608, 610 and local EPC 620 may each run on processor 602 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method of handling Stream Control Transmission Protocol (SCTP) packets comprising:
embedding bits in an SCTP verification tag during SCTP association to identify a correct backend-server instance;
parsing the verification tag to obtain an embedded instance number of the backend server; and
routing, based on the embedded instance number, the SCTP packets to a correct backend server for further processing.

2. The method of claim 1 further comprising discarding an SCTP abort and shutdown complete packet by a backend server that does not have an SCTP association.

3. The method of claim 2 further comprising clearing, by the correct backend server an SCTP association.

4. The method of claim 1 further comprising a peer backend server sending an abort and shutdown complete message with a T-bit set to an SCTP load balancer.

5. The method of claim 4 further comprising looking up, by the SCTP load balancer, the task and tunneling the abort towards a backend server based on a verification tag.

6. The method of claim 5 further comprising wherein the SCTP abort and shutdown complete message contains the verification tag when the T-bit is set, and the selected backend server multicasts the SCTP abort message to all remaining backend servers listening on a same IP and port.

7. The method of claim 6 further comprising the backend server with the peer SCTP association processes the abort message and other backend servers ignore the message.

8. A wireless network system comprising:
a Stream Control Transmission Protocol (SCTP) load balancer;
a plurality of backend servers, each backed server in communication with the SCTP load balancer;
wherein bits are embedded in an SCTP verification tag during SCTP association to identify a correct backend server instance;
the verification tag is parsed to obtain an embedded instance number of the backend server; and
the SCTP packets are routed to a correct backend server for further processing based on the embedded instance number.

9. The wireless network system of claim 8 further comprising wherein an SCTP abort and shutdown complete packet is discarded by a backend server that does not have an SCTP association.

10. The wireless network system of claim 9 further comprising wherein the correct backend server clears an SCTP association.

11. The wireless network system of claim 8 further comprising wherein a peer backend server sends an abort and shutdown complete message with a T-bit set to an SCTP load balancer.

12. The wireless network system of claim 11 further comprising wherein the SCTP load balancer looks up the task and tunnels the abort towards a backend server based on a verification tag.

13. The wireless network system of claim 12 further comprising wherein the SCTP abort and shutdown complete message contains the verification tag when the T-bit is set, and the selected backend server multicasts the SCTP abort message to all remaining backend servers listening on a same IP and port.

14. The wireless network system of claim 13 further comprising wherein the backend server with the peer SCTP association processes the abort message and other backend servers ignore the message.

15. A non-transitory computer-readable medium containing instructions for handling Stream Control Transmission Protocol (SCTP) packets which, when executed, cause the system to perform steps comprising:
embedding bits in an SCTP verification tag during SCTP association to identify a correct backend-server instance;
parsing the verification tag to obtain an embedded instance number of the backend server; and
routing, based on the embedded instance number, the SCTP packets to a correct backend server for further processing.

16. The non-transitory computer-readable medium of claim 15 further comprising instructions for discarding an SCTP abort and shutdown complete packet by a backend server that does not have an SCTP association.

17. The non-transitory computer-readable medium of claim 16 further comprising instructions for clearing, by the correct backend server an SCTP association.

18. The non-transitory computer-readable medium of claim 15 further comprising instructions for a peer backend server sending an abort and shutdown complete message with a T-bit set to an SCTP load balancer.

19. The non-transitory computer-readable medium of claim 18 further comprising instructions for looking up, by the SCTP load balancer, the task and tunneling the abort towards a backend server based on a verification tag.

20. The non-transitory computer-readable medium of claim 19 further comprising instructions for wherein the SCTP abort and shutdown complete message contains the verification tag when the T-bit is set, and the selected backend server multicasts the SCTP abort message to all remaining backend servers listening on a same IP and port and wherein the backend server with the peer SCTP association processes the abort message and other backend servers ignore the message.
